(19) United States
(12) Patent Application Publication
(10) Pub. No.: US 2007/0032584 A1
(43) Pub. Date: Feb. 8, 2007

(54) Compositions and methods for reducing static charge build-up in a polymeric material

(75) Inventors: Frank P. Lochel, Simpsonville, SC (US); Michael W. Watson, Greenville, SC (US)

Correspondence Address: DORITY & MANNING, P.A., POST OFFICE BOX 1449, GREENVILLE, SC, 29602-1449, US

(73) Assignee: Rutgers Organics

(21) Appl. No.: 11/195,452

(22) Filed: Aug. 2, 2005

(51) Int. Cl. C08K 5/00

(52) U.S. Cl. 524/284; 524/605

(57) ABSTRACT

A polymeric material resistant to the build up of static charge is disclosed, along with processes for achieving the same. According to the present invention, an anti-stat agent is combined with a thermoplastic polymer to form a polymeric material that is resistant to the build-up of static charge. The anti-stat agent of the present disclosure can be a derivatized fatty molecule, such as a derivatized fatty alcohol or a derivatized fatty acid. In one embodiment, the fatty molecule can be alkoxylated to form an alkoxylated fatty molecule, such as an ethoxylated fatty molecule. Additionally, in another embodiment, the alkoxylated fatty molecule can be reacted with a phosphoric compound.

### PRIORITY INFORMATION

This application claims priority to, and incorporates by reference, the Provisional Application No. (not yet assigned) having the title “Compositions and Methods for Reducing the Static Charge Build-Up on a Polymeric Material” filed on Feb. 4, 2005 (originally assigned non-provisional application Ser. No. 11/051,975, request to convert to a provisional application filed on May 5, 2005, Attorney Docket No. CIY-16).

### BACKGROUND OF THE INVENTION

Polymeric materials comprising either natural and/or synthetic polymers can accumulate a static charge on the surface of the polymeric material. Also, products made from these polymeric materials tend to accumulate and can retain a static charge for an extended period of time.

Static charge is typically generated through frictional contact between two surfaces. The frictional contact causes one surface to lose electrons, becoming positively charged. The other surface gains electrons, becoming negatively charged. The charged surfaces are said to have a build-up of static charge.

Accumulation of a static charge can create many problems in both the manufacture and application of the polymeric materials. For instance, a static charge build-up in the polymeric material can introduce a hazardous electrical discharge in the manufacturing environment. Also, static charge build-up can add to the cost of production, packaging, and shipping of polymeric materials and product. Another disadvantage of a build-up of static charge is that the surface of polymeric materials can experience static charge built-up, resulting in the tendency of the surface to collect dust.

Polyesters and thermoplastic polymers are particularly subject to accumulation of an electric charge because they are generally poor electrical conductors. In order to help prevent a charge build-up, the equipment used in the manufacturing of the polyesters and thermoplastic polymers is typically grounded to discharge any build-up of static charge in the polyester. However, the grounding of the equipment can be costly and complicated. Additionally, the grounding of the equipment can only temporarily help solve the static charge build-up problem in the polyester, since the polymer can continue to accumulate a static charge after leaving the grounded equipment.

For example, polyesters, such as polyethylene terephthalate (PET), can be particularly subject to the build-up of a static charge in films, pellets, containers and other products. For instance, during the development of PET, a charge can develop during the extrusion step of manufacture. This charge can result in a dangerous discharge of electricity. Further, the static charge may remain in the plastic products made from PET, which can attract dust onto the products, such as plastic bottles, giving an unsightly appearance of being on the shelf for a long period. For instance, films comprising PET generally have a surface resistivity of about 10¹³ Ohms/square, indicating the build-up of a static charge in the film.

In the polyester and thermoplastic polymer industry, there have been many attempts to reduce the static charge build-up in polymeric materials. For instance, an anti-static material, or anti-stat, can be added to the surface of or incorporated into the polymeric material to reduce the build-up of a static charge. However, many current anti-stats for PET known in the art have undesirable side effects, such as yellowing or hazing of the polymeric material.

There is currently a need for an anti-stat agent which can be incorporated into a PET and can reduce or prevent the build-up of static charge without otherwise affecting the properties of the polymeric material or the products and films made with them.

### SUMMARY OF THE INVENTION

In one embodiment, the present invention is directed toward a polymeric material resistant to the build-up of electric charge comprising a thermoplastic polymer and an anti-stat agent, wherein the anti-stat agent comprises a derivatized fatty molecule, such as a derivatized fatty alcohol or a derivatized fatty acid. The thermoplastic polymer can comprise polyethylene terephthalate (PET) or its analogs, such as polyethylene terephthalate glycol (PETG).

In one embodiment, the anti-stat agent of the present invention can comprise an alkoxylated fatty molecule. For example, the anti-stat agent can comprise an ethoxylated fatty molecule. The fatty molecule can be a fatty alcohol, a fatty acid, or the like. Also, the fatty molecule can comprise a saturated or unsaturated hydrocarbon chain. In another embodiment, the alkoxylated fatty molecule can be further reacted with a phosphoric compound to form a phosphoric ester anti-stat agent.

In one embodiment, the anti-stat agent can be added to PET in an amount from about 0.1% to about 10% by weight, such as from about 0.5% to about 2.0%.

### DETAILED DESCRIPTION OF THE INVENTION

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations as come within the scope of the appended claims and their equivalents.

Generally, in accordance with the present invention, an anti-stat agent is combined with a polymeric material to reduce the build-up of static charge in the polymeric material.

One embodiment of the present invention is directed toward a polymeric material and polymeric films and molded parts which are resistant to the build-up of electric charge, which can develop during or after the processing of the polymeric material whether by extrusion or by various types of molding processes or the packaging of the end polymeric products. In another embodiment, the present invention is generally directed toward processes and methods for reducing the build-up of electric charge in polymeric materials and the products made from the polymeric materials.

The amount of static charge build-up in a material can be measured by the surface resistivity of the material. Surface resistivity is a measure of the intensity of electrical current flowing over the surface of the material, quantifying the ability of the surface to conduct electricity in Ohms/square. Generally, an effective anti-static additive or coating is one that will reduce the surface resistivity of the material to which it is applied or incorporated.

According to the present invention, the build-up of static charge in the polymeric material can be reduced by combining an anti-stat agent with the polymeric material. The anti-stat agent can be combined with the host polymeric material by any means known to one skilled in the art at any time during the production of the polymeric material or during production of films, containers, or other products formed from the polymeric material.

For example, the anti-stat agent of the present invention may be applied to the surface of the polymeric material after the extrusion process by any method known in the art, such as spraying, printing, dipping or wiping. Generally, an anti-stat agent applied after the extrusion process is referred to as an external anti-stat agent. However, external anti-stat agents can be particularly susceptible to removal from the polymeric surface. Thus, external anti-stat agents are generally not well adapted for long term reduction of static charge because of the ease in which they can be removed.

Alternatively, an anti-stat agent can be integrated internally into the polymeric material matrix during the production of the polymeric material. Generally, anti-stat agents incorporated into the polymeric material before or during the extrusion process are called internal anti-stat agents. For instance, the anti-stat agent can be simply mixed into the polymeric material after the polymerization of the polymeric material is complete. In one embodiment the anti-stat agent can be incorporated into the polymeric material during the extrusion process.

The polymeric material incorporating an internal anti-stat agent can be processed into any end product that would normally be produced by the polymeric material. For example, PET incorporating an internal anti-stat agent can be made into films, pellets, fibers, containers, and any other end products normally manufactured from PET without substantially changing the properties and characteristics of the polymeric material or the products made with the polymeric material.

For example, the anti-stat agent of the present invention is substantially non-hazing to the host polymeric material. Without wishing to be bound by theory, an additive is non-hazing if the solubility of the additive is such that it does not interfere with the chemical structure or the refractive index of the extruded films or molded parts of the polymeric material. The films and molded parts of the polymeric material can remain transparent with the addition of a non-hazing additive.

Additionally, many additives to PET create an undesirable yellowing of the PET, which interferes with the clarity of the PET and the resulting PET products. However, combining an anti-stat agent to PET according to the present invention does not substantially yellow or otherwise substantially interfere with the clarity of the PET. Without wishing to be bound by theory, it is believed that to be a non-yellowing additive, the additive must be thermally stable at the extrusion and forming temperatures of the polymeric material so the additive does not chemically degrade, preventing any color formation of the additive.

Also, the anti-stat agent of the present invention can be migratory. A migratory additive is one that will migrate to the surface of the polymeric film or molded parts. If the migratory additive is removed from the surface by physical or chemical action, then the migratory additive will regenerate a new additive film on the surface of the film or molded parts. Generally, the additive will have two functional groups, one that is more soluble with the host polymeric material than the other. The less soluble component of the additive will tend to migrate toward the surface of the polymeric material, while the more soluble component of the anti-stat agent will tend to stay within the polymeric material matrix.

The rate an additive migrates can depend on a number of factors known to one skilled in the art, including the relative solubility of the additive and the polymeric material, the crystallinity of the polymeric material, and the concentration of the additive. Additionally, one skilled in the art can substantially control the migration rate of the additive by adjusting the additive's characteristics to change one of the rate factors.

According to the present invention, the polymeric material can be any plastic material that has the tendency to build-up a static charge, including but not limited to polyesters and thermoplastic polymers. For instance, the polymeric material can comprise a thermoplastic polymer, such as polyethylene terephthalate (PET).

In general, the anti-stat-agent of the present invention comprises a fatty molecule, such as a fatty alcohol or a fatty acid. In one embodiment, the anti-stat agent of the present invention can comprise a derivatized fatty molecule, such as a derivatized fatty alcohol or a derivatized fatty acid.

As used herein, a derivatized fatty molecule is a fatty molecule that has been reacted with at least one other compound. For example, the derivatized fatty molecule, in one embodiment, can be alkoxylated to form an alkoxylated fatty molecule. Additionally, for instance, the alkoxylated fatty molecule can be further reacted with a phosphoric compound, such as phosphorous pentoxide, polyphosphoric acid, or the like.

In one embodiment, the anti-stat agent of the present invention can comprise a derivatized fatty alcohol. Fatty alcohols are long chain alcohols typically having the formula of
R—OH
wherein R represents a hydrocarbon chain, either saturated or unsaturated. The hydrocarbon chain of the fatty alcohol can be of any length, such as comprising from about 10 to about 26 carbons, for example from about 12 to about 22 carbons. Alternatively, in other embodiments, the hydrocarbon chain can comprise from about 18 carbons to about 26 carbons. For instance, in one particular embodiment, the fatty alcohol can have a hydrocarbon chain comprising 18 carbons.

The hydrocarbon chain on the derivatized fatty alcohol anti-stat agent can be either saturated or unsaturated fatty alcohols, including both monounsaturated and polyunsaturated fatty alcohols. A saturated carbon chain means that all the carbon to carbon bonds in the hydrocarbon chain are single bonds, allowing the maximum number of hydrogens to bond to each carbon, thus the chain is “saturated” with hydrogen atoms.

An unsaturated hydrocarbon chain means that the carbon chain contains at least one carbon to carbon double bond, thereby reducing the number of hydrogens present on the chain. A monounsaturated hydrocarbon chain contains one carbon to carbon double bond, while a polyunsaturated hydrocarbon chain contains at least two carbon to carbon double bonds.

Many fatty alcohols have common names, relating to their corresponding hydrocarbon chain, to describe the alcohol. The hydrocarbon chains can also be described by the number of carbon atoms present in the chain and the number and location of any double bonds present in the chain, represented by n:m^{Δp,p′,p″}, where n is the number of carbons in the hydrocarbon chain, m is the number of carbon to carbon double bonds in the chain, p is the location of the first double bond (if present), p′ is the location of the second double bond (if present), p″ is the location of the third double bond (if present), and so on.

Examples of saturated fatty alcohols that can be used as an anti-stat agent include, but are not limited to, lauryl alcohol (12:0), tridecyl alcohol (13:0), myristil alcohol (14:0), pentadecyl alcohol (15:0), cetyl alcohol (16:0, also known as palmityl alcohol), heptadecyl alcohol (17:0), stearyl alcohol (18:0), arachidyl alcohol (20:0), and behenyl alcohol (22:0).

Derivatives of unsaturated fatty alcohols can also be used as anti-stat agents according to the present disclosure. In fact, the present inventor has realized that anti-stat agents comprising unsaturated hydrocarbon chains can provide advantages and benefits over anti-stat agents comprising a saturated hydrocarbon chain. Without wishing to be bound by theory, it is believed that the excess electrons (also known as π electrons) contained in the hydrocarbon chain of an unsaturated fatty molecule can help dissipate static charge.

In one particular embodiment, the anti-stat agent can comprise a conjugated unsaturated hydrocarbon chain. Without wishing to be bound by theory, it is believed that a conjugated hydrocarbon chain provides even improved electron mobilization than that of a non-conjugated unsaturated hydrocarbon chain because of the proximity of the free π electrons in the conjugated carbon to carbon double bonds.

Examples of unsaturated fatty alcohols that can be used as an anti-stat agent include, but are not limited to, palmitoleyl alcohol (16:1^{Δ9}), oleyl alcohol (18:1^{Δ9}), linoleyl alcohol (18:2^{Δ9,12}), conjugated linoleyl alcohol (18:2^{Δ9,11}), linolenyl alcohol (18:3^{Δ9,12,15}), γ-linolenyl alcohol (18:3^{Δ6,9,12}), eicosenoyl alcohol (20:1), eicosadienoyl alcohol (20:2^{Δ11,14}), arachidonyl alcohol (20:4^{Δ5,8,11,14}), cetoleyl alcohol (22:1^{Δ11}), and erucyl alcohol (22:1^{Δ13}).

Also, in some embodiments, the hydrocarbon chain of the fatty molecule can comprise a reactive group. For instance, the hydrocarbon chain can comprise an acrylate group.

In one embodiment, the anti-stat agent of the present disclosure can be a derivative of a fatty alcohol. For example, a fatty alcohol as described above can be alkoxylated to form an alkoxylated fatty alcohol, also known as an alcohol alkoxylate. Such as, in one embodiment, the fatty alcohol can be ethoxylated to form an ethoxylated fatty alcohol, also known as an alcohol ethoxylate. For example, the fatty alcohol can be reacted with from 1 mole to about 10 moles of ethoxylate, such as from about 2 to about 8 moles. For instance, in one particular embodiment, the fatty alcohol can be reacted with about 6 moles of ethoxylate, or, in another embodiment, may be reacted with 2 moles of ethoxylate. In yet another embodiment, the fatty alcohol can be reacted with 1 mole of ethoxylate.

The resulting product of the fatty alcohol ethoxylation can generally be represented by the following formula:
R—O—(CH₂CH₂O)ₙH
where R is the carbon chain of the fatty alcohol and n is an integer from 1 to about 10, such as from about 2 to about 8. In one particular embodiment, for example, n can be about 6.

In another embodiment of the present invention, the anti-stat agent can comprise a derivatized fatty acid. Fatty acids have a similar structure to fatty alcohols described above and can be represented by the following formula: 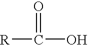
where R represents a hydrocarbon chain, either saturated or unsaturated.

In this embodiment, the fatty acid anti-stat agents can have the same hydrocarbon chains as described above in reference to fatty alcohols. For instance, the hydrocarbon chain of the fatty alcohol can be of any length, such as comprising from about 10 to about 26 carbons, for example from about 12 to about 22 carbons. Alternatively, in other embodiments, the hydrocarbon chain can comprise from about 18 carbons to about 26 carbons. For instance, in one particular embodiment, the fatty acid can have a hydrocarbon chain comprising 18 carbons.

Like fatty alcohols, fatty acids can be saturated, monounsaturated, or polyunsaturated. In one particular embodiment, the fatty acid can be comprise a conjugated hydrocarbon chain.

Many fatty acids have common names, relating to their hydrocarbon chain, that describe the molecule. In fact, most the fatty alcohols listed above, either saturated or unsaturated, have a corresponding fatty acid molecule with a similar common name. Those corresponding fatty acids are included, as well as others, within the scope of this disclosure.

Also, in this embodiment, the fatty acid can be derivatized by alkoxylation as described above in reference to the derivatized fatty alcohol embodiment. For example, the fatty acid can be ethoxylated to form a derivatized fatty acid represented by the following structure: 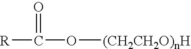
where R is the hydrocarbon chain of the fatty acid, either saturated or unsaturated.

In yet another embodiment, the derivatized fatty molecule, such as a derivatized fatty alcohol or a derivatized fatty acid, can be reacted with a phosphoric compound to form a phosphate ester. For instance, an alkoxylated fatty alcohol or an alkoxylated fatty acid can be further reacted with a phosphoric compound to form a phosphate ester. The phosphate ester can be a monoester or a diester. For example, the phosphoric compound can be phosphorous pentoxide or polyphosphoric acid.

In this embodiment, when the fatty alcohol is reacted with phosphorous pentoxide, the resulting product is a phosphate diester generally having the following formula: 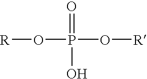
where R is an alkoxylated fatty alcohol chain or an alkoxylated fatty acid chain; and R′ is an alkoxylated fatty alcohol chain, an alkoxylated fatty acid chain, or H.

In one embodiment, the phosphate ester comprising the derivatized fatty molecule can also comprise an acrylate reactive group. For example, the antistat agent can comprise both a phosphonate ester and ethoxy hydrophilicity, a nominal C₁₈ alkyl chain with an acrylate reactive group.

For example, in one embodiment, the derivatized fatty molecule, such as a derivatized fatty alcohol or a derivatized fatty acid, can be the anionic alkoxylate surfactant disclosed in U.S. Pat. No. 6,335,314 issued on Jan. 1, 2002 to Salter, et al, the disclosure of which is hereby incorporated by reference in its entirety.

In one particular embodiment, for example, the phosphoric ester anti-stat agent comprising an alkoxylated fatty molecule can be the compound sold under the trade name CHEMSTAT ASM™ available from the Chemax Division of Rutgers Organics, located at 30 Old Augusta Road, Piedmont, S.C. 29673.

The anti-stat agent can be combined with the polymeric material such that the anti-stat agent comprises from about 0.1% to about 10% of by weight of the polymeric material. For instance, the anti-stat agent can comprise from about 0.5% to about 2.0% of the polymeric material, such as about 1% of the polymeric material. The anti-stat agent can be added to the polymeric material either alone or in combination with other additives or anti-stat agents.

In one embodiment, water can be associated with the anti-stat agent. Such as, in one embodiment, the polymeric material and anti-stat agent can be combined then exposed to a humid environment, allowing water vapor to associate with the polymeric material.

For instance, water can be associated with the anti-stat agent after the anti-stat agent has been incorporated into the polymeric material. For example, the anti-stat agent can be added to the polymeric material, then the polymeric material comprising the anti-stat agent can be molded into the final product, such as a container. Once the anti-stat agent is in the final product of the polymeric material, the anti-stat agent can migrate to the surface of the polymeric material where it can attract water molecules. For example, after extruding the anti-stat agent into the polymer, the anti-stat can migrate to the surface of the polymeric material where the anti-stat agent can attract water.

The polymeric material incorporating the anti-stat agent can be formed into any end product that would typically produced from the particular polymeric material. For example, thermoplastic polymers incorporating the anti-stat agent of the present invention can be made into films or molded into any shape that is desired. For instance, PET incorporating an anti-stat agent of the present invention can be made into films, pellets, fibers, containers, bottles, and other products.

In one embodiment, the anti-stat agent can be added to the polymeric material, such as mixed into the polymeric material in its resin form. Then, the polymeric material and the anti-stat agent mixture can be extruded, such as melt-blending, into a molded form. For instance, an ethoxylated fatty alcohol phosphate ester and/or an ethoxylated fatty acid phosphate ester can be added to PET in its resin form. Then the mixture can be extruded into a film or a molded material, such as a container.

In another embodiment, the anti-stat agent of the present invention can be compounded with the polymeric material. For instance, PET resin and an anti-stat agent according to the present disclosure can be melt-blended together forming compounded pellets.

In another embodiment, the anti-stat agent can be added to the polymeric material during the formation of the films or molded parts and products, such as during the extrusion of the polymeric material. For instance, the anti-stat agent can be added to PET during the extrusion of the PET into films or molded parts, such as containers, pellets, or the like.

In one embodiment, the anti-stat agent can be added to PET in such a concentration that a final product made from the PET anti-stat mixture, such as a film or molded part, comprises from about 0.1% to about 10% anti-stat agent by weight, such as about 0.1% to about 5%. For instance, in one embodiment, the PET anti-stat mixture can comprise from about 0.5% to about 2% anti-stat agent by weight, such as about 1%.

The final product produced from the polymeric material incorporating the anti-stat agent of the present disclosure can have a lower surface resistivity than that of the polymeric material without the anti-stat agent present. For example, PET normally has a surface resistivity of about 10¹³ Ohms/sq. However, when PET is mixed with an anti-stat agent according to the present disclosure, the resulting PET and anti-stat agent material can have a surface resistivity of less than about 10¹³ Ohms/sq, such as less than about 10¹² Ohms/sq. For instance, in one embodiment, the PET and anti-stat agent material can have a surface resistivity of less than about 10¹¹ Ohms/sq. Furthermore, in yet another embodiment, the resulting PET and anti-stat agent material can have a surface resistivity of less than about 10¹⁰ Ohms/sq, such as less than about 10⁹ Ohms/sq.

### EXAMPLE

A polymeric material incorporating an anti-stat agent was formed by combining and mixing PET and the product sold under the trade name CHEMSTAT ASM™ available from the Chemax Division of Rutgers Organics, located at 30 Old Augusta Road, Piedmont, S.C. 29673, at 1% by weight of the PET. Then, the polymeric material was extruded into a film.

The resulting polymeric film's surface resistivity (measured in Ohms/sq) was compared to that of a film of PET without an anti-stat agent, as shown in Table 1. The surface resistivity measurements were conducted by a Resistance/Current Meter, Model 278 sold by Electro-Tech Systems, Inc. of Glenside, Pa.

| | Initial | 3 Day | 21 Day | 60 Day | 90 Day |
|---|---|---|---|---|---|
| Polymeric | surface | surface | surface | surface | surface |
| Material | resistivity | resistivity | resistivity | resistivity | resistivity |
| PET | 10¹³ | 10¹³ | 10¹³ | 10¹³ | 10¹³ |
| PET and | 10¹⁰ | 10¹⁰ | 10⁹ | 10⁹ | 10⁹ |
| anti-stat | | | | | |
| agent | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymeric material resistant to the build-up of electric charge comprising:
a thermoplastic polymer, and
an anti-stat agent, wherein said anti-stat agent comprises a derivatized fatty molecule, wherein the fatty molecule comprises an unsaturated hydrocarbon chain comprising from about 12 to about 26 carbons.

2. The polymeric material of claim 1, wherein the thermoplastic polymer comprises polyethylene terephthalate.

3. The polymeric material of claim 2, wherein the polymeric material has a surface resistivity of less than about 10¹² Ohms/sq.

4. The polymeric material of claim 2, wherein the polymeric material has a surface resistivity of less than about 10¹¹ Ohms/sq.

5. The polymeric material of claim 2, wherein the polymeric material has a surface resistivity of less than about 10¹⁰ Ohms/sq.

6. The polymeric material of claim 1, wherein the unsaturated hydrocarbon chain comprises a conjugated polyunsaturated hydrocarbon chain.

7. The polymeric material of claim 1, wherein the derivatized fatty molecule comprises a derivatized fatty alcohol.

8. The polymeric material of claim 1, wherein the derivatized fatty molecule comprises a derivatized fatty acid.

9. The polymeric material of claim 1, wherein the fatty molecule has been alkoxylated to form an alkoxylated fatty molecule.

10. The polymeric material of claim 9, wherein the alkoxylated fatty molecule comprises an ethoxylated fatty molecule.

11. The polymeric material of claim 9, wherein the alkoxylated fatty molecule has been further reacted with a phosphoric compound.

12. The polymeric material of claim 11, wherein the phosphoric compound is selected from the group consisting of polyphosphoric acid and phosphorous pentoxide.

13. The polymeric material of claim 1, wherein the polymeric material is molded into a final product.

14. The polymeric material of claim 1, wherein the anti-stat agent comprises from about 0.1% to about 10% by weight of the final molded product.

15. The polymeric material of claim 1, wherein the anti-stat agent comprises from about 0.5% to about 2% by weight of the final molded product.

16. The polymeric material of claim 1, wherein the polymeric material is melt-blended together.

17. The polymeric material of claim 1, wherein the polymeric material is a film.

18. The polymeric material of claim 1, wherein the polymeric material is a container.

19. The polymeric material of claim 1, wherein the polymeric material is a pellet.

20. The polymeric material of claim 1, wherein the polymeric material is a fiber.

21. A polymeric material resistant to the build-up of electric charge comprising:
a thermoplastic polymer, and
a phosphoric ester comprising an ethoxylated fatty molecule,
wherein the ethoxylated fatty molecule comprises a hydrocarbon chain comprising from about 10 to about 26 carbons.

22. The polymeric material of claim 21, wherein the thermoplastic polymer comprises polyethylene terephthalate.

23. The polymeric material of claim 21, wherein the ethoxylated fatty molecule is an ethoxylated unsaturated fatty molecule.

24. The polymeric material of claim 23, wherein the ethoxylated unsaturated fatty molecule is an ethoxylated unsaturated fatty alcohol.

25. The polymeric material of claim 24, wherein the unsaturated fatty alcohol is selected from the group consisting of palmitoleyl alcohol, oleyl alcohol, linoleyl alcohol, conjugated linoleyl alcohol, linolenyl alcohol, γ-linolenyl, eicosenoyl alcohol, eicosadienoyl alcohol, arachidonyl alcohol, cetoleyl alcohol, and erucyl alcohol.

26. The polymeric material of claim 24, wherein the unsaturated fatty alcohol is selected from the group consisting of linoleyl alcohol and conjugated linoleyl alcohol.

27. The polymeric material of claim 21, wherein the ethoxylated fatty molecule comprises an ethoxylated saturated fatty molecule.

28. The polymeric material of claim 21, wherein the phosphoric ester is formed from a phosphoric compound selected from the group consisting of polyphosphoric acid and phosphorous pentoxide.

29. The polymeric material of claim 21, wherein the polymeric material is melt-blended together.

30. The polymeric material of claim 21, wherein the polymeric material has a surface resistivity of less than about 10¹¹ Ohms/sq.

31. The polymeric material of claim 21, wherein the polymeric material has a surface resistivity of less than about 10¹⁰ Ohms/sq.

32. The polymeric material of claim 21, wherein the anti-stat agent comprises from about 0.1% to about 10% by weight of the final molded product.

33. The polymeric material of claim 21, wherein the anti-stat agent comprises from about 0.5% to about 2% by weight of the final molded product.

34. A method for reducing static charge build-up in a polymeric material, comprising:
providing an anti-stat agent comprising an ethoxylated fatty molecule, wherein the fatty molecule comprises an unsaturated hydrocarbon chain comprising from about 10 to about 26 carbons; and
combining the anti-stat agent with a thermoplastic polymer.

35. The method of claim 34, wherein the thermoplastic polymer comprises polyethylene terephthalate.

36. The method of claim 34, wherein the unsaturated hydrocarbon chain comprises a conjugated polyunsaturated hydrocarbon chain.

37. The method of claim 34, wherein the ethoxylated fatty molecule comprises an ethoxylated fatty alcohol.

38. The method of claim 34, wherein the ethoxylated fatty molecule has been further reacted with a phosphoric compound selected from the group consisting of polyphosphoric acid and phosphorous pentoxide.

39. The method of claim 34, wherein the anti-stat agent comprises between about 0.1% to about 10% of the polymeric material by weight.

40. The method of claim 34, wherein the anti-stat agent comprises between about 0.5% to about 2% of the polymeric material by weight.
